(19) United States
(12) Patent Application Publication
(10) Pub. No.: US 2008/0068198 A1
(43) Pub. Date: Mar. 20, 2008

(54) Pen set equipped with a loss alarm mechanism

(75) Inventor: Wei-Chin Chen, Taipei (TW)

Correspondence Address: BIRCH STEWART KOLASCH & BIRCH, PO BOX 747, FALLS CHURCH, VA, 22040-0747, US

(73) Assignee: SPEADA INDUSTRIAL CO., LTD.

(21) Appl. No.: 11/518,164

(22) Filed: Sep. 11, 2006

(51) Int. Cl. G08B 21/00; G08B 1/08

(52) U.S. Cl. 340/686.6; 340/539.21; 340/539.23; 340/539.32

(57) ABSTRACT

A pen set equipped with a loss alarm mechanism aims to generate an alarm signal when a radio transmitter is spaced from the pen set at an excessive distance thereby prevent an article which contains the radio transmitter from getting lost.

### FIELD OF THE INVENTION

The present invention relates to a pen set and particularly to a pen set equipped with a loss alarm mechanism to prevent an article which contains a radio transmitter from getting lost.

### BACKGROUND OF THE INVENTION

These days many people, especially those in business, often carry a lot of expensive electronic devices to do businesses instantly, such as mobile phones, Bluetooth earphones, PDAs, portable computers, iPods, MP3 and the like. Those electronic devices could be lost inadvertently for people in a rush. This not only results in loss of money, loss of confidential data stored in the electronic devices could cause serious damages to users. To remedy this problem, R.O.C. patent publication No. I234984 discloses a mobile phone equipped with loss-preventing function. It includes a microprocessor to coordinate operations of the mobile phone, a vibration sensor to detect vibration of the mobile phone timely and generate a trigger signal when the vibration of the mobile phone exceeds a preset vibration value, and an alarm unit to generate an alarm signal when the vibration sensor generates the trigger signal.

However, the loss-preventing handset mentioned above activates the detection mode to determine whether the handset is lost only after the handset has vibrated. If the vibration mode is turned off, the loss-preventing function is ineffective. To maintain the loss-preventing function, the vibration mode has to be turned on constantly. It is troublesome for users.

### SUMMARY OF THE INVENTION

The primary object of the present invention is to prevent an article which contains a radio transmitter from getting lost. Through the radio transmitter and a radio receiver it determines whether a pen set carried by a user and the article contained the radio transmitter are spaced from each other at an excessive distance. In the event that an excessive distance is detected, an alarm on the pen set instantly alerts the user to look after the article which contains the radio transmitter.

To achieve the foregoing object, the pen set according to the invention includes a radio transmitter and a pen set which has an alarm and a radio receiver to receive radio signals from the radio transmitter. The alarm is electrically connected to the radio receiver. When the radio receiver and the radio transmitter are spaced from each other greater than a preset range, the radio signal received by the radio receiver becomes abnormal and the alarm generates an alarm signal.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of an embodiment of the invention;

FIG. 2 is a schematic view of an embodiment of the radio transmitter of the invention;

FIG. 3 is a schematic view of an embodiment of the pen set of the invention; and

FIG. 4 is a table showing operating conditions of an embodiment of the alarm of the present invention.

### DETAILED DESCRIPTION OF THE PREFERRED EMBODIMENT

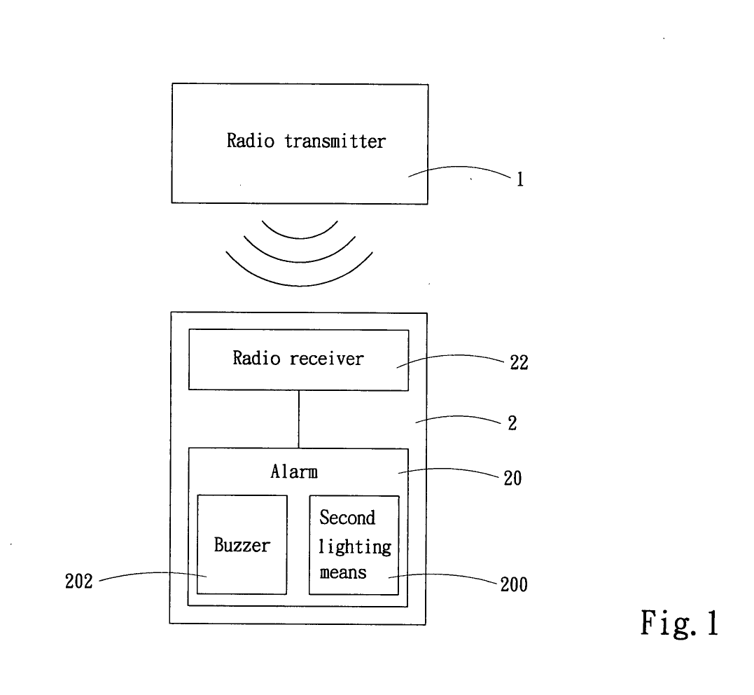

Please refer to FIG. 1 for a block diagram of an embodiment of the invention. The pen set equipped with a loss alarm mechanism according to the invention includes a radio transmitter 1 contained in an article and a pen set 2. The pen set 2 includes an alarm 20 and a radio receiver 22 to receive radio signals from the radio transmitter 1. The alarm 20 is electrically connected to the radio receiver 22. When the radio receiver 22 is spaced from the radio transmitter 1 at a distance greater than a present range, the radio receiver 22 determines an abnormal condition, and the alarm 20 generates an alarm signal.

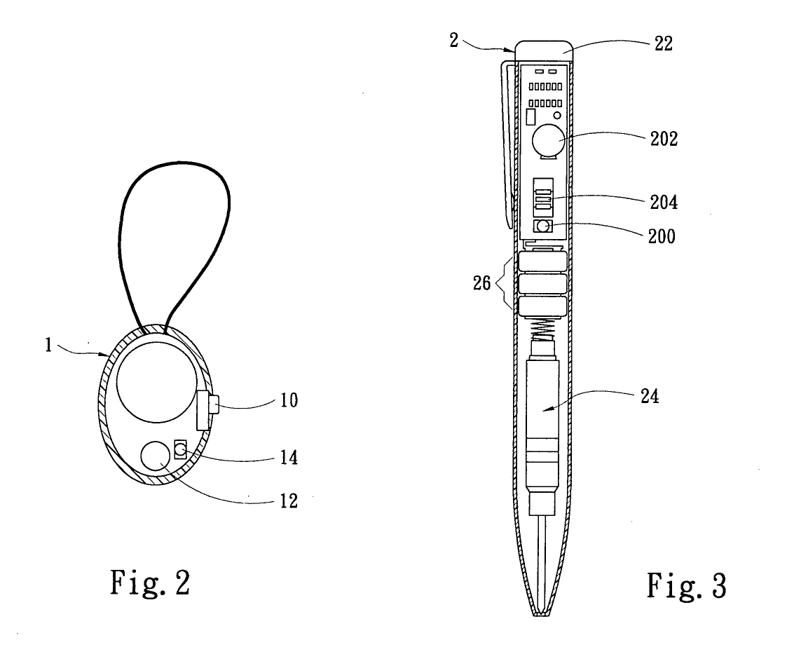

Referring to FIGS. 2 and 3, the radio transmitter 1 is electrically connected to a first switch 10, a first power supply module 12 and a first lighting means 14. The first switch 10 aims to set the radio transmitter 1 ON and OFF. The first power supply module 12 provides electric power required on the radio transmitter 1 and the first lighting means 14. In this embodiment, the first power supply module 12 is a mercury battery. The first lighting means 14 indicates whether the radio transmitter 1 is ON or OFF.

The pen set 2 contains a core 24 for writing and a second power supply module 26 to provide electric power required by the alarm 20. In this embodiment, the second power supply module 26 is a mercury battery. In addition, the alarm 20 contains a second lighting means 200, a buzzer 202 and a second switch 204 to set the alarm 20 ON and OFF. The second lighting means 200 generates a blinking signal when the radio signal waveform received by the radio receiver 22 is abnormal to alert users that the article carrying the radio transmitter 22 is spaced from the pen set 2 at a distance greater than the present range. Then the buzzer 202 is driven by the radio receiver 22 to generate an audio signal to alert the users that the article carrying the radio transmitter 1 is spaced from the pen set 2 at a distance greater than the present range.

It is to be noted that, in this embodiment the signal waveform (such as signal definition or signal power) transmitted between the radio transmitter 1 and the radio receiver 22 is used to determine whether the distance between the two is too much. In practice, whether the spaced distance is excessive can also be determined by a signal transmitted constantly from the radio transmitter 1 to the radio receiver 22.

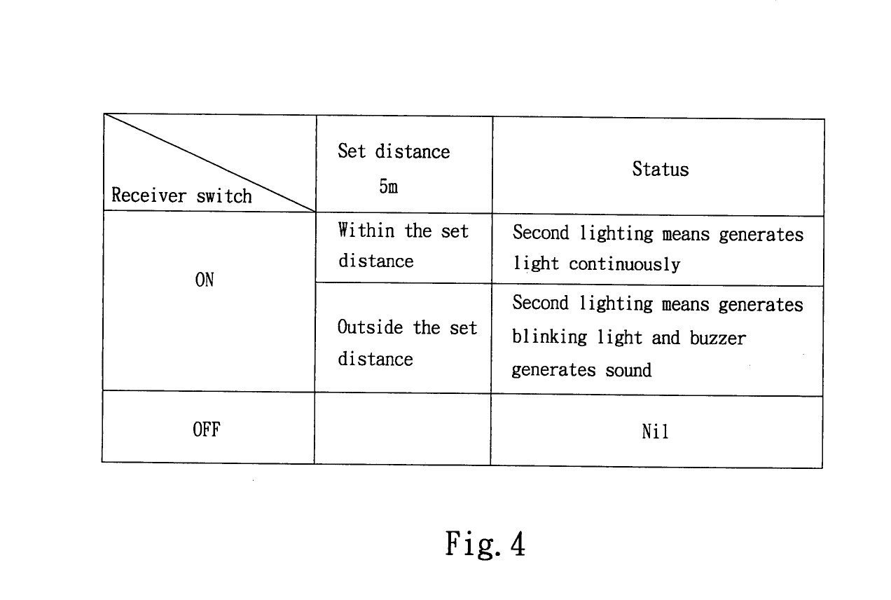

Refer to FIG. 4 for operating conditions of an embodiment of the alarm of the invention. First, set a distance range and impact to the radio signal when the distance between the radio receiver 22 and the radio transmitter 1 exceeds the preset range. In this embodiment, the preset range is 5 meters. The radio signal received by the radio receiver 22 from the radio transmitter 1 located five meters away is abnormal. If such a condition occurs, the second lighting means 200 generates blinking light and the buzzer 202 generates an audio signal to alert users. If the distance is within the preset range, the second lighting means 200 generates light constantly while the buzzer 202 stops output of the audio signal and is silence.

In short, the invention actuates the second lighting means 200 to generate blinking light and the buzzer 202 to generate an audio signal when the radio receiver 22 is spaced from the radio transmitter 1 at a distance greater than the preset range that affects the radio signal. Hence users are alerted by the carrying pen set 2 that the article containing the radio transmitter 1 is located too far away and an immediate action should be taken to prevent the article from getting lost. This invention contains novel functions and provides a significant improvement over the conventional techniques.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments which do not depart from the spirit and scope of the invention.

What is claimed is:

1. A pen set equipped with a loss alarm mechanism, comprising:
a radio transmitter; and
a pen set which includes an alarm and a radio receiver to receive radio signals from the radio transmitter,
wherein the alarm is electrically connected to the radio receiver, the radio signals received by the radio receiver being determined abnormal when the distance between the radio receiver and the radio transmitter exceeds a preset range and the alarm generating an alarm signal.

2. The pen set equipped with a loss alarm mechanism of claim 1, wherein the alarm includes a buzzer, the alarm signal generated by the buzzer being an audio signal.

3. The pen set equipped with a loss alarm mechanism of claim 1, wherein the alarm includes a lighting means, the alarm signal generated by the lighting means being a blinking signal.

4. The pen set equipped with a loss alarm mechanism of claim 1, wherein the radio signals received by the radio receiver being determined abnormal depends on the waveform of the signals.
